(19) United States
(12) Patent Application Publication
(10) Pub. No.: US 2010/0048265 A1
(43) Pub. Date: Feb. 25, 2010

(54) Antenna mounting arrangement for cell phone with a metal casing

(76) Inventor: Chi-Ming Chiang, Pa-Te City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,005

(22) Filed: Aug. 21, 2008

(51) Int. Cl. H04M 1/02

(52) U.S. Cl. 455/575.7

(57) ABSTRACT

An antenna mounting arrangement for a cell phone having a plastic bottom shell, a metal front cover and a printed circuit board with a ground plane set in between the plastic bottom shell and the metal front cover metal is disclosed to have the ground pin of the antenna be electrically connected to the ground plane of the printed circuit board and the metal front cover of the cell phone to change the direction of electric current through the antenna and to further change the distribution of the magnetic field of the cell phone for increasing the antenna efficiency.

### BACKGROUND OF THE INVENTION

1. Field of the Invention

The present invention relates to antennas and more particularly, to such an antenna mounting arrangement for a cell phone with a meta casing.

2. Description of the Related Art

In some cell phone designs, a metal casing may be used to surround the circuit board and the antenna so as to achieve a particular function, for example, to protect the cell phone against damage. However, the shielding effect of the metal casing may lower the antenna efficiency.

U.S. Pat. No. 7,327,324 discloses an antenna design, entitled “Monopole slot antenna”, in which FIG. 5(a) shows metal and plastic radiotelephone casings having a slot antenna. According to this design, the antenna is connected with the metal radiotelephone casing.

In a conventional cell phone with a metal casing, the antenna is a radiator of a metallic planar sheet surrounded by a non-metal material, for example, plastic member, and the feed pin and grounding pin of the antenna are extended to the outside and respectively electrically connected to the feed contact and ground contact of the circuit board. The ground contact of the circuit board is electrically connected to the ground plane. This antenna design results in a poor antenna efficiency, an improvement in this regard is necessary. Therefore, it is desirable to provide an antenna mounting arrangement that eliminates the aforesaid problem.

### SUMMARY OF THE INVENTION

The present invention has been accomplished under the circumstances in view. It is therefore the main object of the present invention to provide an antenna mounting arrangement, which increases the antenna efficiency.

To achieve this and other objects of the present invention, the antenna mounting arrangement comprises a cell phone and an antenna mounted in the cell phone. The cell phone comprises a plastic bottom casing, a metal front cover, and a printed circuit board with a ground plane set in between the plastic bottom casing and the metal front cover. The antenna has the ground pin thereof electrically connected to the ground plane of the printed circuit board and the metal front cover of the cell phone to change the direction of electric current through the antenna and to further change the distribution of the magnetic field of the cell phone for increasing the antenna efficiency.

### BRIEF DESCRIPTION OF THE DRAWINGS

FIG. 1 is an exploded view of the preferred embodiment of the present invention.

FIG. 1A is an oblique bottom view of the antenna shown in FIG. 1.

FIG. 2 is a sectional assembly view of a part of the preferred embodiment of the present invention.

### DETAILED DESCRIPTION OF THE PREFERRED EMBODIMENT

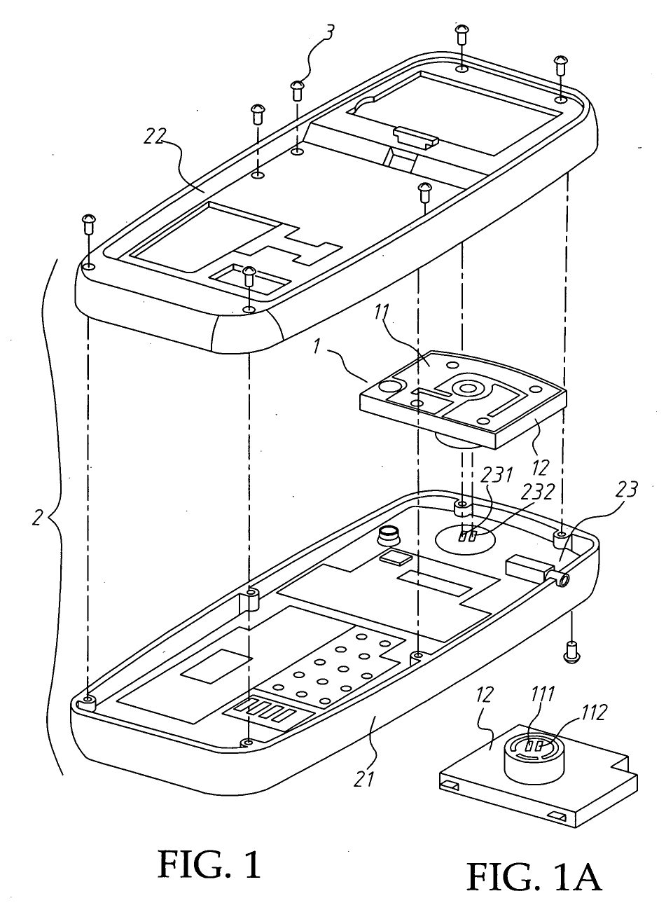

Referring to FIG. 1, an antenna 1 is shown installed in a cell phone 2. The cell phone 2 comprises a plastic bottom casing 21, a metal front cover (metal top casing) 22, and a printed circuit board 23 with a ground plane set in between the plastic bottom casing 21 and the metal front cover 22.

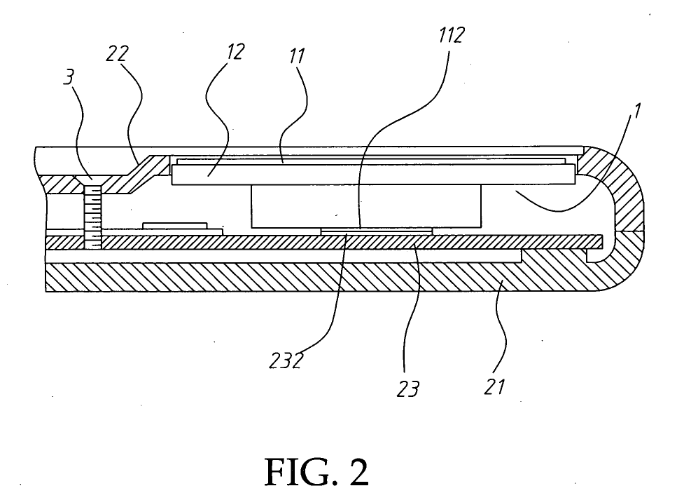

The antenna 1 comprises a substrate 12 and a radiator 11 of a metallic planar sheet mounted on the substrate 12. As shown in FIG. 1A, the metallic radiator 11 has a feed pin 111 and a ground pin 112 respectively extended to the bottom side of the substrate 12. After installation, the feed pin 111 and the ground pin 112 are respectively and electrically connected to a feed contact 231 and a grounding contact 232 of the printed circuit board 23. The ground pin 112 of the antenna 1, the ground plane of the printed circuit board 23 and the metal front cover 22 are electrically connected together by means of, for example, threading metal screws 3 through the metal front cover 22 into the printed circuit board 23, as shown in FIG. 2. By means of changing the direction of electric current through the antenna 1, the distribution of the magnetic field of the cell phone 2 is relatively changed, thereby increasing the radiation efficiency of the antenna 1.

The following tables show the results of tests made on antennas connected with a metallic shell and antennas without connection:

Antenna connected with metal casing 2D Gain H-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −2.8 | −2 | −4.2 | −6.8 | −4.8 | −5.3 | −7.1 |
| (dBm) | | | | | | | |
| Peak EIRP (dBm) | −1.568 | −1.043 | −3.042 | −4.748 | −2.334 | −2.533 | −4.366 |
| Min. (dBm) | −4.066 | −2.802 | −5.36 | −10.59 | −7.625 | −8.492 | −12.15 |
| Directivity (dBi) | 1.216 | 0.922 | 1.109 | 2.1 | 2.459 | 2.76 | 2.767 |
| Efficiency (dB) | −2.784 | −1.966 | −4.151 | −6.848 | −4.793 | −5.294 | −7.133 |
| Gain (dBi) | −1.568 | −1.043 | −3.042 | −4.748 | −2.334 | −2.533 | −4.366 |
| Average Gain | −2.784 | −1.966 | −4.151 | −6.848 | −4.793 | −5.294 | −7.133 |
| (dB) | | | | | | | |
| Horizontal Tot. | −3.008 | −2.204 | −4.589 | −8.533 | −6.84 | −7.834 | −9.927 |
| Rad. Pwr. (dBm) | | | | | | | |
| Vertical Tot. | −15.77 | −14.68 | −14.33 | −11.77 | −9.045 | −8.83 | −10.37 |
| Rad. Pwr. (dBm) | | | | | | | |

Antenna connected with metal casing 2D Gain E-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −6.2 | −5.6 | −7.4 | −5.8 | −3.7 | −3.2 | −4.6 |
| (dBm) | | | | | | | |
| Peak EIRP (dBm) | −3.587 | −2.724 | −4.669 | −1.113 | 1.299 | 2.381 | 0.937 |
| Min. (dBm) | −15.54 | −15 | −17.42 | −17.15 | −14.5 | −11.74 | −12.47 |
| Directivity (dBi) | 2.583 | 2.916 | 2.698 | 4.691 | 4.986 | 5.536 | 5.511 |
| Efficiency (dB) | −6.17 | −5.64 | −7.366 | −5.804 | −3.687 | −3.155 | −4.574 |
| Gain (dBi) | −3.587 | −2.724 | −4.669 | −1.113 | 1.299 | 2.381 | 0.937 |
| Average Gain | −6.17 | −5.64 | −7.366 | −5.804 | −3.687 | −3.155 | −4.574 |
| (dB) | | | | | | | |
| Horizontal Tot. | −15.87 | −13.89 | −13.69 | −14.29 | −11.47 | −10.84 | −11.76 |
| Rad. Pwr. (dBm) | | | | | | | |
| Vertical Tot. | −6.661 | −6.344 | −8.521 | −6.467 | −4.478 | −3.967 | −5.496 |
| Rad. Pwr. (dBm) | | | | | | | |

Antenna connected with metal casing 2D Gain E2-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −5.7 | −5.2 | −7.2 | −6.2 | −4.2 | −3.9 | −6 |
| (dBm) | | | | | | | |
| Peak EIRP (dBm) | −2.381 | −2.228 | −4.31 | −2.183 | 0.108 | 0.127 | −2.292 |
| Min. (dBm) | −17.31 | −19.61 | −19.92 | −12.47 | −10.06 | −9.256 | −10.41 |
| Directivity (dBi) | 3.271 | 2.962 | 2.892 | 4.048 | 4.275 | 4.05 | 3.704 |
| Efficiency (dB) | −5.653 | −5.189 | −7.201 | −6.231 | −4.168 | −3.923 | −5.996 |
| Gain (dBi) | −2.381 | −2.228 | −4.31 | −2.183 | 0.108 | 0.127 | −2.292 |
| Average Gain | −5.653 | −5.189 | −7.201 | −6.231 | −4.168 | −3.923 | −5.996 |
| (dB) | | | | | | | |
| Horizontal Tot. | −14.39 | −13.61 | −15.46 | −10.8 | −8.571 | −8.041 | −9.749 |
| Rad. Pwr. (dBm) | | | | | | | |
| Vertical Tot. | −6.276 | −5.864 | −7.904 | −8.098 | −6.125 | −6.052 | −8.372 |
| Rad. Pwr. (dBm) | | | | | | | |

Antenna without connection to metal casing 2D Gain H-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −5.8 | −5.8 | −5.8 | −14 | −11 | −13 | −13 |
| (dBm) | | | | | | | |
| Peak EIRP (dBm) | −4.545 | −4.565 | −4.624 | −10.88 | −8.604 | −9.922 | −9.765 |
| Min. (dBm) | −6.827 | −6.748 | −7.109 | −27.93 | −20.87 | −20.32 | −17.65 |
| Directivity (dBi) | 1.273 | 1.205 | 1.167 | 2.633 | 2.504 | 2.941 | 3.358 |
| Efficiency (dB) | −5.818 | −5.77 | −5.791 | −13.51 | −11.11 | −12.86 | −13.12 |
| Gain (dBi) | −4.545 | −4.565 | −4.624 | −10.88 | −8.604 | −9.922 | −9.765 |
| Average Gain | −5.818 | −5.77 | −5.791 | −13.51 | −11.11 | −12.86 | −13.12 |
| (dB) | | | | | | | |
| Horizontal Tot. | −6.047 | −5.959 | −6.04 | −16.02 | −14.32 | −16.89 | −15.8 |
| Rad. Pwr. (dBm) | | | | | | | |
| Vertical Tot. | −18.72 | −19.48 | −18.33 | −17.09 | −13.92 | −15.05 | −16.5 |
| Rad. Pwr. (dBm) | | | | | | | |

Antenna without connection to metal casing 2D Gain E-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −9.6 | −9.7 | −9.4 | −14 | −12 | −13 | −10 |
| (dBm) | | | | | | | |
| Peak EIRP (dBm) | −6.674 | −6.712 | −6.641 | −9.04 | −6.615 | −6.882 | −3.586 |
| Min. (dBm) | −17.74 | −17.72 | −22.06 | −32.07 | −25.75 | −29.9 | −20.75 |
| Directivity (dBi) | 2.932 | 2.967 | 2.79 | 5.417 | 5.441 | 5.913 | 6.716 |
| Efficiency (dB) | −9.606 | −9.679 | −9.431 | −14.46 | −12.06 | −12.79 | −10.3 |
| Gain (dBi) | −6.674 | −6.712 | −6.641 | −9.04 | −6.615 | −6.882 | −3.586 |
| Average Gain | −9.606 | −9.679 | −9.431 | −14.46 | −12.06 | −12.79 | −10.3 |
| (dB) | | | | | | | |
| Horizontal Tot. | −16.67 | −17.72 | −17 | −20.36 | −15.89 | −15.79 | −15.25 |
| Rad. Pwr. (dBm) | | | | | | | |
| Vertical Tot. | −10.56 | −10.42 | −10.27 | −15.75 | −14.37 | −15.82 | −11.98 |
| Rad. Pwr. (dBm) | | | | | | | |

Antenna without connection to metal casing 2D Gain E2-PLANE

| | Frequency | | | | | | |
|---|---|---|---|---|---|---|---|
| | 880 | 920 | 960 | 1710 | 1800 | 1880 | 1990 |
| Ant. Port Input Pwr. | 0 | 0 | 0 | 0 | 0 | 0 | 0 |
| (dBm) | | | | | | | |
| Tot. Rad. Pwr. | −9.9 | −9.8 | −9.4 | −15 | −12 | −13 | −11 |
| (dBm) | | | | | | | |
| Peak EIRP (dBm) | −6.989 | −7.369 | −6.18 | −9.233 | −6.375 | −7.155 | −6.431 |
| Min. (dBm) | −20.65 | −24.76 | −22.68 | −29.18 | −22.7 | −21.88 | −20.56 |
| Directivity (dBi) | 2.912 | 2.385 | 3.188 | 5.79 | 5.814 | 6.006 | 4.902 |
| Efficiency (dB) | −9.902 | −9.754 | −9.368 | −15.02 | −12.19 | −13.16 | −11.33 |
| Gain (dBi) | −6.989 | −7.369 | −6.18 | −9.233 | −6.375 | −7.155 | −6.431 |
| Average Gain | −9.902 | −9.754 | −9.368 | −15.02 | −12.19 | −13.16 | −11.33 |
| (dB) | | | | | | | |
| Horizontal Tot. | −18.61 | −18.25 | −17.87 | −20.44 | −17.69 | −18.2 | −16.76 |
| Rad. Pwr. (dBm) | | | | | | | |
| Vertical Tot. | −10.53 | −10.42 | −10.03 | −16.49 | −13.62 | −14.8 | −12.8 |
| Rad. Pwr. (dBm) | | | | | | | |

Subject to the aforesaid test results, the antenna arrangement of a cell phone with a metal casing according to the present invention increases the antenna efficiency when compared to conventional designs without connection to a metal casing. Therefore, the design of the present invention involves inventive step.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An antenna mounting arrangement comprising a cell phone and an antenna mounted in said cell phone, said cell phone comprising a plastic bottom shell, a metal front cover, and a printed circuit board having a ground plane set in between said plastic bottom shell and said metal front cover metal, wherein said antenna comprises a ground pin electrically connected to the ground plane of said printed circuit board and said metal front cover to change the direction of electric current through said antenna in changing the distribution of the magnetic field of said cell phone, increasing the radiation efficiency.

2. The antenna mounting arrangement as claimed in claim 1, further comprising at least one metal screw driven through said metal front cover into said printed circuit board to electrically connect said ground pin of said antenna and said ground plane of said printed circuit board and said metal front cover of said cell phone together.
